(19) United States
(12) Patent Application Publication
(10) Pub. No.: US 2010/0009706 A1
(43) Pub. Date: Jan. 14, 2010

(54) Method for controlling the weighting of a data signal in the at least two antenna elements of a radio connection unit, radio connection unit, module and communications system

(75) Inventors: Ari Hottinen, Espoo (FI); Risto Wichman, Helsinki (FI); Olav Tirkkonen, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/081,761

(22) Filed: Apr. 21, 2008

Related U.S. Application Data
(63) Continuation of application No. 11/723,509, filed on Mar. 20, 2007, now abandoned.
Application No. 11/723,509 is a continuation of application No. 10/433,094, filed on Aug. 25, 2003, now abandoned.

(51) Int. Cl. H04B 7/00

(52) U.S. Cl. 455/517

(57) ABSTRACT

The invention relates to a method for controlling the weighting of a data signal in the at least two antenna elements of a first radio connection unit of a radio communications system, which data signal is to be distributed for parallel transmission to a second radio connection unit to at least two beams. In order to improved such a method, it comprises: determining in the second radio connection unit a weight information enabling the first radio connection unit to determine the sets of weights for suitable beams for transmission and transmitting it to the first radio connection unit; and distributing the data signal in the first radio connection unit to those sets of weights and transmitting the data signals simultaneously via the formed beams. Alternatively or additionally, the second unit determines the number of beams to be used and informs the first unit about it. The invention equally relates to corresponding radio connection units, radio connection unit modules and radio communications systems.

### FIELD OF THE INVENTION

The invention relates to a method for controlling the weighting of a data signal in the at least two antenna elements of a first radio connection unit of a radio, communications system, which data signal is to be distributed to at least two beams for parallel transmission of the data signal in at least two at least partly different streams to a second radio connection unit with at least one antenna element, the beams being formed by weighting the data signal in the antenna elements with a set of weights for each beam. The invention equally relates to a radio connection unit, a radio connection unit module and a radio communications system to be employed for such a method.

### BACKGROUND OF THE INVENTION

It is known from wireless communications systems of the state of the art to transmit data signals between two radio connection units, in particular from a base station to a terminal, in parallel via several transmit antenna elements. When using multiple antennas with adapted transmission and detection techniques, the spatial dimension can be exploited at the terminal and the spectral efficiency of fading wireless channels can be increased significantly compared to conventional single antenna links. A terminal receiving signals from such a transceiver can be designed to distinguish several channels, if they are sufficiently uncorrelated.

The document “Link-Optimal BLAST Processing With Multiple-Access Interference” by F. R. Farrokhi, G. J. Foschini, A. Lozano, R. A. Valenzuela, Bell Laboratories (Lucent Technologies) in IEEE Vehicular Technology Conference, Boston, Mass., USA, Sep. 24-28, 2000, proceeds from a wireless communications system with antenna arrays at both, transmitter and receiver. The system transmits parallel data streams simultaneously and in the same frequency band, using the multiple antennas. With rich propagation, the different streams can be separated at the receiver because of their distinct spatial signatures. It is proposed to make the channel and the interference covariance available to the transmitter. The transmitter finds the channel eigenmodes in the presence of the interference and sends multiple independent data streams through those eigenmodes. The total transmitted power is distributed among the eigenmodes according to an optimal water-fill process. Thereby, the maximised capacity is supposed to be achieved. The method, as described above, always assumes that the receiver has at least two antenna elements. Preferably, in the aforementioned concept, the number of transmit and receive elements is the same.

The parallel transmission via a plurality of antenna elements in transceiver and terminal enables a reduction of Eb/No (Eb=energy per bit; No=noise power density per Hz) requirements for achieving data rates associated with higher order constellations like 8 PSK, 16 QAM, or 64 QAM. Moreover, it enables the expansion of the number of rate options for adaptive modulation and coding (AMC) and an increase of the maximum rate.

### SUMMARY OF THE INVENTION

It is an object of the invention to provide a further improved method for controlling the weighting of a data signal in the at least two antenna elements of a transceiver of a wireless communications system which allows for high data rates in the downlink matched to channel conditions.

This object is reached on the one hand by a first method for controlling the weighting of a data signal in the at least two antenna elements of a first radio connection unit of a radio communications system, which data signal is to be distributed to at least two beams for parallel transmission of the data signal in at least two at least partly different streams to a second radio connection unit with at least one antenna element, the beams being formed by weighting the data signal in the antenna elements with a set of weights for each beam, the method comprising:
determining in the second radio connection unit a weight information enabling the first radio connection unit to determine the sets of weights for at least two suitable beams for transmission of a data signal from the first radio connection unit to the second radio connection unit;
transmitting the determined weight information to the first radio connection unit; and
distributing the data signal in the first radio connection unit to at least two sets of weights determined from the received weight information and transmitting the data signals simultaneously via the at least two formed beams.

With regard to this first method, the invention proceeds from the idea that the second radio connection unit is in possession of the most comprehensive information relevant for selecting suitable beams for transmission of the data signal and for determining sets of weights for the selected beams. It is therefore proposed to calculate all relevant information needed for the weighting of the data signals in the antenna elements of the first radio connection unit already at the second radio connection unit. The feedback information includes a weight information from which the first radio connection unit can determine the set of weights for each beam that is to be used for transmission of the data signals from the first radio connection unit to the second radio connection unit. Each feedback information indicates the weighting of the data signal for each of the different antenna elements of the first radio connection unit. This way, the information needed for obtaining the weight sets can be determined with the full information present at the second radio connection unit, while only the information needed is fed back to the first radio connection unit.

It is to be noted that the feedback information can include the set of weights for each selected beam, the first radio connection unit only having to apply the received sets for forming the selected beams. It is not required, however, that the second radio connection unit determines and transmits all sets of weights, if there exists an a priori fixed or negotiated way of calculating multiple weights from a single feedback known to both, first and second radio connection unit. Then, a reduced feedback information is sufficient, which enables the first radio connection unit to determine the necessary sets of weights. Therefore, the second radio connection unit controls the parallel beams with weight information either directly using explicit feedback for all beams or implicitly using reduced feedback and the knowledge of beam parameterisation at the first radio connection unit.

On the other hand, the object is reached by a second method for controlling the weighting of a data signal in the at least two antenna elements of a first radio connection unit of a radio communications system, which data signal is to be distributed to at least two beams for parallel transmission of the data signal in at least two at least partly different streams to a second radio connection unit with at least one antenna element, the beams being formed by weighting the data signal in the antenna elements with a set of weights for each beam, said second method comprising:
determining in the second radio connection unit the number of beams to be used for transmission of a data signal from the first radio connection unit to the second radio connection unit;
providing the first radio connection unit with information about the determined number of beams; and
distributing the data signal in the first radio connection unit to the number of beams corresponding to the number of beams determined in the second radio connection unit.

Just like in the first proposed method, in the second proposed method according to the invention, the second radio connection unit makes use of its knowledge in order to determine an information relevant for beamforming in the first radio connection unit and transmits this information to the first radio connection unit. The difference is that here, the information may include the number of beams that are to be formed by the first radio connection unit.

Both methods are aimed at controlling the weighting of a data signal that is to be divided, usually after encoding and modulation, into at least two parts for transmission. At least partly different symbols are therefore transmitted in parallel using the at least two formed beams, even though the symbols transmitted by the two beams do not have to be completely different.

The weight information for the selected beams and the number of beams respectively can be signalled to the first radio connection unit using any feasible technique known in the state of the art.

The transmitted data signals can be received at the second radio connection unit by one antenna element or by several antenna elements.

The above stated object of the invention is equally reached by a radio connection unit that can be used as first and/or as second radio connection unit, comprising means respectively for realising the methods according to the invention. Moreover, the object is reached by radio connection unit modules comprising means for realising the methods according to the invention in a first or second or a combined first and second radio connection unit. Finally, also a radio communications system with radio connection units suitable for realising the methods according to the invention reaches this object of the invention.

Preferred embodiments of the invention become apparent from the subclaims.

In the first method according to the invention, the second radio connection unit preferably determines the set of weights for at least two dominant downlink beams that are spatially sufficiently independent or uncorrelated for reception at said second radio connection unit. The sets of weights for forming the downlink beams that are fed back to the first radio connection unit can be calculated at the second radio connection unit so that they enable an efficient signal separation at the receiver. As an example, if the two most dominant beams are highly correlated, the first radio connection unit and the second radio connection unit can use only one of them for an efficient parallel transmission. In this case, only one of those most dominant beams is used and in addition another dominant beam with a smaller eigenvalue but which is sufficiently different from the two most dominant beams. With sufficient information about the beamforming at the first radio connection unit, again, instead of all needed sets of weights only some reduced weight information from which several sets of weights can be determined can be transmitted to the first radio connection unit as feedback information.

In a further preferred embodiment of the first of the proposed methods, the second radio connection unit not only determines the downlink beams and the corresponding weight information indicating the sets of weights that are to be used for multiple transmission, but also the data rates to be used for each of the selected beams. The data rates are determined in the second radio connection unit according to the characteristics of the received channels and information about the determined data rates is transmitted to the first radio connection unit. This means, the data rate mapping to multiple beams is done at least partially using a second radio connection unit to first radio connection unit feedback. Thereby, the downlink data rate using multiple transmit beams or weight sets can be maximised. In order to be able to assign the data rates, the signal-to-noise ratio (SNR) or signal-to-interference ratio (SIR), or signal-to-noise-plus-interference ratio (SINR) of the different channels can be evaluated. Moreover, with correlated channels, the data rate should typically be reduced regardless of the number of transmit or receive antenna elements. The data rates can be determined in a way that the total data rate remains constant. Advantageously, however, the total data rate is determined in a way that it coincides with a data rate requested by the terminal and that the associated transmission power supports the quality-of-service (QoS) criteria (e.g. SIR, SNR, SINR, Bit Error Ratio BER, Frame Error Rate FER, Outage) set for the transmitted service by the terminal.

The information about changes in the data rates transmitted from the second to the first radio connection unit can be differential or absolute. In the first case, e.g. only a requested increase or decrease in a data rate has to be indicated in the feedback, while in the second case, the data rate can change arbitrarily, but more feedback is required.

The determination of multi-rate beams is preferably done in the second radio connection unit by taking into account the effective signal-to-noise ratio for parallel beams and by using in addition the knowledge of the receiver structure in the second radio connection unit. For example, some receivers can be better suited for mitigating inter-beam interferences than others. Furthermore, the inter-beam interference can be optimised when controlling jointly the transmit powers, weight coefficients and data rates.

In an equally preferred embodiment of the first method according to the invention, the second radio connection unit determines alternatively or in addition to the data rate distribution an advantageous power distribution over the selected downlink beams. Like the data rates, also the power distribution is determined in the second radio connection unit according to the characteristics of the received channels. The second radio connection unit transmits information about this distribution to the first radio connection unit for controlling the antenna elements accordingly. Equivalent as for the data rates, the total power over all used beams can be kept constant.

The optimal power allocation can be determined in a way that the desired SIR is met after the sets of weights have been fixed. A downlink power assignment for the power of downlink beams with fixed beam coefficients from a base station to a number of terminals is described in “Optimal downlink power assignment for smart antenna systems” by Weidong Yang; Guanghan Xu, in Acoustics, Speech and Signal Processing, 1998; Proceedings of the 1998 IEEE, Vol. 6, pp. 3337-3340. This approach can be adapted for the first method of the invention to be used to jointly determine the powers and the QoS parameters for each of several parallel downlink beams from a first radio connection unit to a given second radio connection unit rather than for the power of downlink beams from a base station to multiple users, where to each user there is assigned one beam.

Alternatively, the transmit powers for the downlink beams can be determined jointly with the determination of the set of weights or corresponding weight information for the optimal beams. In the document “Joint Optimal Power Control and Beamforming in Wireless Networks Using Antenna Arrays”, by F. Rashid-Farrokhi, L. Tassiulas, and K. J. Ray Liu, IEEE Transactions On Communications, vol. 46, no. 10, October 1998, pp. 1313-1323, an algorithm is provided for computing transmission powers and beamforming weight vectors, such that a target SINR is achieved for each link from one base station to a plurality of terminals with minimal transmission power. In the documents, it is proposed that for a fixed power allocation, each base station maximises the SINR using the minimum variance distortionless response (MVDR) beamformer. Next, the mobile powers are updated to reduce the cochannel interference. This operation is done iteratively until the vector of transmitter powers and the weight coefficients of the beamformers converge to the jointly optimal value. Assuming that at least two spatial channels have been estimated for the second radio connection unit, the sets of weights and the power optimisation techniques proposed by Farrokhi et al. can be used in the first method of the invention to determine multiple beams for parallel transmission from the first to the (single) second radio connection unit instead of from a base station to multiple users. As a result, the second radio connection unit has all relevant information for optimising the beams and for distributing the signals to at least two parallel beams.

Furthermore, for determining the at least two suitable downlink beams, channel information and/or interference information can be used in the second radio connection unit. A possibility for determining an interference covariance matrix that can be used in the method according to the invention to calculate the optimal eigenvectors at the second radio connection unit, is described e.g. in “Maximum Likelihood Multipath Channel Parameter Estimation in CDMA Systems”, by C. Sengupta, A. Hottinen, J. R. Cavallaro, and B. Aazhang, 32nd Annual Conference on Information Sciences and Sysetms (CISS), Princeton, March 1998.

The weight information, which may include the sets of weights, and/or the data rates and/or the power distribution can be determined in the second radio connection unit either based on short term variations of the received channels or based on the stationary structure of the received channels or on a combination of both. In a slowly fading channel, short term variations can be used to determine the weight information and related data rate information. Alternatively, short term information can be used for signalling only the data rate and/or the power information for beams that are determined by using the stationary structure of the received channels. With short term variations, high resolution beams can be calculated such that the instantaneous data rate is maximised. This, of course, works only in slowly fading environments.

In case the stationary structure of the received channels is used for determining the weight information for the at least two downlink beams, preferably the eigenvectors of the spatial signal covariance matrices are calculated. However, the weight information for the preferred beams can be calculated in any other suitable way. For example, the subspace weight vectors can be tracked with a singular value decomposition and subspace tracking, which does not require the calculation of the correlation matrix and a subsequent eigenvalue decomposition. Such a tracking can be taken e.g. from “Solving the SVD Updating Problem for Subspace Tracking on a Fixed Sized Linear Array of Processors” by C. Sengupta, J. R. Cavallaro, and B. Aazhang, International Conference on Acoustics, Speech, and Signal Processing (ICASSP), Volume 5, pp. 4137-4140, Munich, April 1997. Alternatively, an independent component analysis can be applied, as described e.g. by J. F. Cardoso and P. Comon in: “Independent Component Analysis, a Survey of Some Algebraic methods”, Proc. ISCAS Conference, volume 2, pp. 93-96, Atlanta, May 1996. In this case, the beams transmitted in parallel are typically non-orthogonal.

In a preferred embodiment of the second method according to the invention, the second radio connection unit determines the number of beams to be used for transmission of a data signal from the first radio connection unit to the second radio connection unit based on channel and/or interference information.

As one possibility for transmitting the information about the determined number of beams in the second method according to the invention, the determined number of beams to be used for transmission of a data signal from the first radio connection unit to the second radio connection unit can simply be indicated by the number of beams that are transmitted from the second radio connection unit to the first radio connection unit. As mentioned above, the number of beams can also be included in the number of sets of weights determined and transmitted as proposed for the first method according to the invention.

In the second method according to the invention, the first radio connection unit can signal in addition to the number of beams beam indices selected for transmission, enumerated in some way.

The first method according to the invention can, but does not necessarily, include the second method according to the invention. That means, in the first method according to the invention, the number of beams to be used can be determined first in the second radio connection unit and for this number of beams, sets of weights are determined and transmitted to the first radio connection unit, or the number is included in the weight information if this weight information does not include the complete set of weights to be used. Alternatively, the number of sets of weights determined in the second radio connection unit can be fixed.

In both methods according to the invention, the second radio connection unit should recover the data signals distributed to the at least two beams in the first radio connection unit and transmitted in at least two at least partly different streams to the second radio connection unit. This means, the parts transmitted by different streams have to be combined again in the correct symbol/bit order.

In a preferred embodiment of both methods according to the invention, the first radio connection unit transmits weight information used for beamforming to the second radio connection unit and the second radio connection unit uses the received weight information for evaluation of the received data signals. With this knowledge, the quality and the speed in determining information to be transmitted to the first radio connection unit can be improved. In an alternative embodiment for the first method of the invention, the second radio connection unit can make use of its own knowledge included in the weight information transmitted to the first radio connection unit for recovering the data signals. In both embodiments, the second radio connection unit can use the channel estimates obtained for each antenna element, the transport format information, and the used beam coefficients for each beam in order to detect and decode the information most efficiently. The receiver can use any techniques known in the art to that end, including joint detection, joint decoding, joint detection/decoding and channel estimation implemented either iteratively, or non-iteratively. As an example, techniques analogous to those described in A. Hottinen and O. Tirkkonen, “Iterative decoding and detection in a high data rate downlink channel,” Proc. NORSIG, Kolmorden, Sweden, June 2000, can be used.

In both methods of to the invention, the first radio connection unit can be a base station and the second radio connection unit a terminal, the formed beams being downlink beams. Equally, the first radio connection unit can be a terminal and the second radio connection unit a base station, the formed beams being uplink beams. Consequently, the methods can also be employed with a base station and a terminal which can both form the first radio connection unit and the second radio connection unit.

The proposed method is of particular advantage when used in FDD systems.

The first and second radio connection units are preferably base stations and user equipments, where base station and user equipment can include either only means for one of the first and the second radio connection unit or means for both.

### DETAILED DESCRIPTION OF THE INVENTION

In the following, the invention is explained in more detail for three embodiments.

All three embodiments of a method according to the invention relate to a WCDMA FDD wireless communications system, in which data signals are to be transmitted with a very high data rate from a base station to a user equipment. The base station comprises an antenna array with M antenna elements and the user equipment comprise an antenna array with N antenna elements. The data signals are transmitted in parallel and with the same frequency, but with different beams from the base station to the user equipment.

The beams are formed by assigning a different set of weights to the data signals assigned to one beam, the set of weights determining the weighting with which each data bit is transmitted from each antenna element of the base station. To each beam, there is assigned a data rate with which bits are to be transmitted and an output power. The number of beams to be used, the beam weights, the data rates and the power for the selected beams are determined in the user equipment.

The first embodiment of a method according to the invention is proposed for correlated spatial channels. A specific parameterised weight set for the base station antenna array is assumed. That is, it is assumed that the base station has an uniform linear array (ULA); the antennas have equal spacing, which spacing is small enough to allow significant (but not necessarily close to unit) correlation between neighbouring antennas. Under those assumptions, a particular parameterised beam-forming concept is used at the user equipment in which the transmit weight/array vector, parameterised by θ, is given by:

w(θ)=[1, e^{jθ}, . . . , e^{j(M-1)θ}]^{T}/\sqrt{M}

The feedback can be calculated e.g. using the eigenvectors corresponding to the two largest eigenvalues of the channel matrix H^{H}H, where H=h₁, . . . , h_{H}) and where hₘ is the impulse response between the m^{th} array element and all antennas of the user equipment. When denoting these vectors by eₘₐₓ_{_{—}}ᵢ (i=1,2) and solving

$$θ {i}^{*} = arg {max}_{θ i} {‖ {w ( θ i )}^{H} {e}_{max\_i} ‖}^{2} ,$$

the phases at the transmit element m are wₘ=e^{j(m-1)}^{_{θ*}}.

If the user equipment finds it advantageous, some (not necessarily orthogonal) linear combinations of the eigenvectors may be used as a basis for directing the beams from the ULA, instead of the eigenvectors eₘₐₓ_{_{—}}ᵢ. For example, if the data rates that may be assigned to the beams are such that the beam with the highest eigenvalue may support more data than can be transmitted with the highest supportable data rate, the user equipment may choose to select correlating beams, where a suitable mixture of orthogonal beams are used to reach the maximal data rate with an acceptable Quality of Service.

The set of parameters θi for parallel transmission is fed back to the base station applying e.g. Mode 1 feedback signalling. In Mode 1, the feedback bit signals in successive slots the real and the imaginary parts of the feedback weights, or the angular parameters θi in this case. It is also possible to parameterise the gains of the antennas with one or more parameters. One parameterisation would be to have the gains linearly increasing or decreasing along the linear array. Other parameterisation would enhance or suppress the central antenna elements, or every second element. If antenna gains are parameterised, the maximisation above chooses the best angular and gain parameters to match the eigenvectors. This information can be transmitted e.g. by closed-loop Mode 2 signalling. In closed-loop Mode 2, the feedback weight is signalled as a Gray coded message with 3 phase bits and 1 gain bit. The gain bit, transmitted every fourth slot, selects the relative gain between the two transmit elements. Here, Mode 2 signalling would convey information of the angular parameter θi in the phase bits, and one gain parameter in the gain bit.

In addition, the feedback from the terminal to the transmitter can be reduced, if the terminal knows the method the transmitter uses in determining the coefficients for the parallel beams. For example, it is possible that the terminal sends the coefficients or parameters for one beam only, and the base station then determines two or more parallel beams using w(θ−Δ) and w(θ+Δ), where Δ is a priori fixed or negotiated between the transmitter and the terminal, and where θ is the parameter for the two beams. Then, the terminal can optimise θ jointly for w(θ−Δ) and w(θ+Δ), so that there are two parameterised beams transmitted, but with only one feedback signal (θ). This generalises naturally to multiple parallel beams and different ways to calculate the multiple parallel beams from single feedback are possible.

In addition to the weight information, the user equipment determines the data rate to be used by each selected downlink beam. The data signal is to be distributed across the different downlink beams such that the target data rate R is met with minimal transmission power. This target rate may be chosen by the user equipment based on the channel and interference information available. The user equipment therefore assigns to N possible, not necessarily orthogonal beams, the data rates R1 to RN in a way that R=R1+R2+ . . . +RN=const. To this end, the signal-to-noise ratio SNR of the selected beams is evaluated. The selected dominant beam with the highest SNR is assigned the highest data rate and the selected dominant beam with the lowest SNR is assigned the lowest data rate. In addition, the correlation between the channels are taken into account. With high correlation, the data rate per selected beam is reduced, as the supportable (target) data rate has to be decreased. The data rates for the selected downlink beams are contained in additional feedback from the user equipment to the base station.

Equally included in such an additional feedback from the user equipment to the base station is information on the best power distribution for the different selected beams. The power can be assigned by the user equipment in a way that the total output power of the base station is constant, or minimised for a given data rate and quality of service requirement. Also for determining the power distribution, the channel characteristics are evaluated. For example, the lowest output power can be assigned to the selected dominant beam with the highest SNR. Transmitting information about the power distribution of different beams can be advantageously combined with transmitting the phase parameters θi, in feedback Mode 2 signalling. Now, the gain bit would indicate the relative gain of the beam in question, and the phase bits would convey information about the angular parameters θi. Similarly, data rate information can be indicate by the gain bit in Mode 2 signalling.

The processes of choosing the data rates and choosing the power distribution can in some cases be considered complementary, i.e. the effect of using one may be partly generated by using the other.

The base station receives from the user equipment the feedback signals with a set of weights, the data rate and the output power for each selected downlink beam. These feedback information enables the base station to distribute, weight and transmit the data signals in the manner that was determined by the user equipment to be most suitable in the present situation.

The data signals to be transmitted by the base station are split in the base station to multiple downlink beams after channel encoding so that different encoded bits are transmitted from different beams with the assigned power. For coding, e.g. Turbo coding is used and the bits are sequentially sent via the different beams, taking into account the different assigned data rates R1 to RM. Moreover, the bits are suitably interleaved across the spatial channels so that even if one channel or beam has a very low SNR, the data can be decoded. For example, random interleaving, or some optimised interleaving can be used. As an example, with rate ⅓ Turbo encoder that provides systematic bit (x0), parity bit 1 (x1) and parity bit 2 (x2), we can transmit x0 through at least two beams, x1 through beam 1 and x2 through beam 2. Thus, the encoded signal is distributed in at least two beams, with at least partially different contents. Each beam is formed by weighting the supplied encoded data bits in the antenna elements with the corresponding set of weights, which includes weight information for each antenna element for the specific beam. At the terminal, the different parts of the data signals distributed to the different beams are combined again in order to obtain the correct symbol or bit order for channel decoding or for any other following receiver stage.

The second embodiment of the invention is based on an eigenanalysis of the long-term spatial-temporal covariance matrices estimated from the dominant temporal taps with a terminal that has N receive antenna elements. This approach is especially suited for deciding the number of beams to use when correlated spatial channels are expected.

The eigenbeams with the largest eigenvalues and therefore the largest average SNR are determined from the spatial-temporal correlation matrix. The dominant eigenvectors determined by the eigenanalysis are fed back to the base station as sets of weights for downlink beamforming. If the determined weights are fed back to the base station step by step, this process takes place roughly at the same time scale as the physical movement of the user equipment. Such a forming of eigenbeams has been described in “Advanced closed loop Tx diversity concept (eigenbeamformer)”, 3GPP TSG RAN WG 1, TSGR1#14(00)0853 Meeting #14, Jul. 4-7, 2000, Oulu, Finland, by Siemens for selecting diversity transmission beams.

Before or in parallel with transmitting data signals, an orthogonal pilot sequence is transmitted from each base station antenna element to the user equipment. With the received signals, the user equipment is able to estimate the long term spatial covariance matrix R, or matrices Rₙ, of the dominant temporal taps. In the present case, where more than one receiving antenna element is used in the user equipment, the dimension of the correlation matrices is typically increased as compared to one receiving antenna element. Alternatively, the dimension can remain the same regardless of the number of receive antenna elements. In the latter case the receiver operations are simplified, and the correlation matrix for signals and channel coefficients received at different or selected receive antenna elements is given by

R=H^{H}*H with H=[h₁, h₂ . . . h_{H}]

where M is the number of transmit antenna elements and where h₁ (l=1 . . . M) is a (N×L)×1 vector, a concatenation of N impulse response vectors of length L, where N is the number of receive antennas. For obtaining the weight vectors needed for beam forming, the terminal calculates two different vectors from this matrix R, e.g. the eigenvectors corresponding to the two largest eigenvalues of the matrix.

The aforementioned method averages the contributions of each path and receive antenna when calculating the correlation matrix, and subsequently for determining the transmit beam or beams based on the correlation matrix. Instead, it is possible to determine the transmit beam coefficients for each or for selected delay paths, or for selected receive antennas. To this end, multiple correlation matrices are calculated, where for calculating each correlation matrix a different combination of rows from channel matrix H is selected (i.e. a different set of row indices is selected when calculating the correlation matrix). Then, multiple weighting coefficients can be calculated, one corresponding to each row index set. By selecting suitable rows, the terminal can calculate weighting coefficients in a way that different parallel beams are optimised for different receive antennas or different multipath delays, or a combination of the two. Furthermore, the terminal can take into account the interference between the beams, thus effectively optimising the Signal-to-Interference ratio, rather than just the signal power. Notice that here it is sufficient for the terminal to have only one receive antenna, as long as there are at least two delay paths between the transmitter and the terminal.

Long-term properties can be exploited by calculating the weighting coefficients. Assume now that hₙ is an M-dimensional vector corresponding to the n^{th} dominant tap, between M transmit elements and N receive antenna elements at delay path n. The long term channel properties change slowly over time, therefore a forgetting factor ρ is applied to the long term spatial covariance matrix of the n^{th} dominant temporal tap with the equation:

Rₙ(i )=ρRₙ(i−1)+(l−ρ)hₙ(i)hₙ^{H}(i),

where i denotes the slot number and hₙ the vector of spatial channel estimation of the n^{th} temporal tap. By forming the eigenvectors, a decorrelation of the beamforming vectors can be achieved, and thereby a reduction in dimension for subsequent short-term processing and an improved short-term channel estimation at the user equipment enabled by an increase in diversity and antenna gain/interference suppression.

Proceeding from the estimated covariance matrices Rₙ, the terminal performs an eigenanalysis in order to determine the eigenvectors with the equation:

RₙWₙ=WₙΘₙ

for each dominant temporal tap. The eigenvectors to be found are columns of Wₙ. Since the matrix Θₙ, which comprise the eigenvalues of matrices Rₙ, is diagonal by definition, transmission on different eigenbeams leads to uncorrelated fast fading. The diagonal entries of the matrix Θₙ indicate the long-term SNR of each beam. Here, a number of weighting vectors are defined, corresponding to the dominant eigenbeams, based different delay paths. Alternatively, the correlation matrix can be estimated for any other combination of row indices of H. For example, if all rows of H are selected, we need to track only one correlation matrix (average over multiple delay paths or receive antennas) and find at least two dominant eigenvectors or beams from a single matrix. The decision which delay paths and receive antenna paths are used can depend also on the receiver structure. However, the particular way the terminal decides to calculate the long term coefficients need not typically be known by the transmitter. The transmitter only needs to know the actual weighting coefficients that are applied in the transmitter in order to form the at least two beams.

With the calculation of the eigenvectors of the correlation matrices, an automatic adjustment to various propagation environments (spatially correlated or uncorrelated, frequency selective or non-selective) becomes possible. If the channel is spatially correlated, the channel can accurately be described by a small number of weighted eigenbeams. If, on the other hand, the channel has a spatial correlation of zero, no long-term spatial channel information can be exploited and each eigenvector addresses only one antenna element. Thus the user equipment determines from the eigenvalue spread the number of sufficiently independent spatial channels and signals the weight sets for the corresponding downlink beams to the base station. As in the first embodiment, the selected beams may be intentionally correlating, to fully exploit the capacity of the channel.

The sets of weights determined for forming the downlink beams are chosen in a way that they enable an efficient signal separation at the receiver. If the most dominant beams are highly correlated, the transceiver or the terminal can efficiently use only one of them for parallel transmission. In this case, in addition to one of those most dominant beams, another dominant beam with a smaller eigenvalue but which is sufficiently different from the two dominant beams, or a suitable linear combination of beams, is selected.

The data rates and the power used for the different selected downlink beams are determined in the user equipment and transmitted as separate feedback information to the base station, as described with reference to the first embodiment. Also the coding and interleaving of the data signals that are to be transmitted is carried out as described with reference to the first embodiment.

A third embodiment of a method according to the invention can be applied in cases where there are no long term spatial correlations.

The antenna elements are rather uncorrelated and the fading process may be rather fast. The only slowly changing characteristic is the rank of the channel matrix H^{H}H, i.e. the number of non-zero eigenvalues. With a frequency proportional to the expected or actual coherence time of the channel, the user equipment selects at least two beams that are linearly dependent on the eigenvectors related to at least two of the strongest eigenvalues.

As in the first and the second embodiment, the beams need not be orthogonal, and the feedback information may be supplemented with information about data rates and/or relative power distribution of the beams.

The weights corresponding to the selected beams are transmitted to the base station. For this, e.g. Mode 1 or Mode 2 signalling can be used, as explained in connection with the first and the second embodiment.

In the whole, in all three embodiments, all necessary processing for establishing an optimised feedback downlink transmission in a base station with multiple transmission is carried out in the user equipment, the base station only applying the received information.

Finally, it should be noted that the same methods may be applied to uplink transmissions in personal communication systems, or more generally, to any radio communication link with multiple input, multiple (or single) output channels, where a reciprocal channel exists that enables feedback signalling.

1. A method comprising:
determining in a second radio connection unit a weight information enabling a first radio connection unit to determine sets of weights for at least two suitable beams for transmission of a data signal from the first radio connection unit to the second radio connection unit;
evaluating in the second radio connection unit a stationary structure of received channels to determine data rates to be used for each of the at least two suitable beams;
transmitting the determined weight information and the determined data rates to the first radio connection unit; and
distributing the data signal in the first radio connection unit to at least two sets of weights determined from the received weight information and transmitting the data signals simultaneously via the at least two formed beams with the determined data rates.

2. Method according to claim 1, wherein the second radio connection unit determines a weight information enabling the first radio connection unit to determine the set of weights for at least two dominant beams which allow a signal separation at said second radio connection unit.

3. Method according to claim 1, wherein the second radio connection unit determines the data rates to be used for the at least two determined beams.

4. (canceled)

5. Method according to claim 1, wherein the second radio connection unit determines the data rates to be used for the at least two determined beams in a way that the total data rate is met with minimal transmission power.

6. Method according to claim 1, wherein the second radio connection unit determines the power to be used for the at least two determined beams according to the channel characteristics and transmits information with the power to be used to the first radio connection unit.

7. Method according to claim 6, wherein the second radio connection unit determines the power to be used for the at least two determined beams in a way that the total power is constant.

8. Method according to claim 1, wherein channel and interference information is used in the second radio connection unit for determining the weight information enabling the determination of the sets of weights for the at least two suitable beams.

9. Method according to claim 1, wherein the short term variations in the received channels are evaluated in the second radio connection unit for determining the weight information and/or the data rates and/or the power to be used for each of the at least two suitable beams.

10. Method according to claim 1, wherein the stationary structure of the received channels is evaluated in the second radio connection unit for determining the weight information and/or the power to be used for each of the at least two suitable beams.

11. Method according to claim 1, wherein the weight information is determined by an eigenanalysis of spatial covariance matrices representing the stationary structure of the received channels.

12. Method according to claim 1, wherein the stationary structure of the received channels is used in the second radio connection unit for determining the weight information and wherein short term variations in the received channels are used in the second radio connection unit in addition for determining the data rates and the power to be used for said beams.

13. Method according to claim 1, wherein the second radio connection unit recovers the data signals distributed to the at least two beams in the first radio connection unit and transmitted in at least two at least partly different streams to the second radio connection unit.

14. Method according to claim 13, wherein the second radio connection unit uses the weight information transmitted to the first radio connection unit for recovering the data signals.

15. Method according to claim 13, wherein the first radio connection unit transmits a weight information from which the second radio connection unit can determine the sets of weights used for transmission of the data signals to the second radio connection unit and wherein the second radio connection unit uses the weight information for recovering the data signals.

16. Method according to claim 1, wherein the second radio connection unit determines the number of beams to be used for transmission, the transmitted weight information comprising information about the number of beams to be used.

17. Method according to claim 16, wherein the second radio connection unit determines the number of beams to be used for transmission of a data signal from the first radio connection unit to the second radio connection unit based on channel and/or interference information.

18. A method comprising:
determining in a second radio connection unit the number of beams to be used for transmission of a data signal from a first radio connection unit to the second radio connection unit;
providing the first radio connection unit with information about the determined number of beams; and
distributing the data signal in the first radio connection unit to the number of beams determined in the second radio connection unit.

19. Method according to claim 18, wherein the second radio connection unit determines the number of beams to be used for transmission of a data signal from the first radio connection unit to the second radio connection unit based on channel and/or interference information.

20. Method according to claim 18, wherein the determined number of beams to be used for transmission of a data signal from the first radio connection unit to the second radio connection unit is indicated by the number of beams that are transmitted from the second radio connection unit to the first radio connection unit.

21. Method according to claim 18, wherein the second radio connection unit recovers the data signals distributed to the at least two beams in the first radio connection unit and transmitted in at least two at least partly different streams to the second radio connection unit.

22. Method according to claim 21, wherein the first radio connection unit transmits a weight information enabling the second radio connection unit to determine the sets of weights used for transmission of the data signals to the second radio connection unit and wherein the second radio connection unit uses the received weight information for recovering the data signals.

23. Method according to claim 18, wherein the first radio connection unit is a base station and the second radio connection unit a user equipment and wherein the formed beams are downlink beams.

24. Method according to claim 18, wherein the first radio connection unit is a user equipment and the second radio connection unit a base station and wherein the formed beams are uplink beams.

25. Use of a method according to claim 1 in a wideband code division multiple access (WCDMA) Frequency Division Duplex (FDD) system.

26. Radio connection unit for a wireless communications system comprising at least two antenna elements and means for realizing as first radio connection unit the method according to claim 1.

27. Radio connection unit for a wireless communications system comprising at least one antenna element and means for realizing as second radio connection unit the method according to claim 1.

28. Radio connection unit for a wireless communications system, comprising at least two antenna elements, and means for realizing as first radio connection unit and as second radio connection unit the method according to claim 1.

29. Radio connection unit according to claim 26, wherein the radio connection unit is a base station.

30. Radio connection unit according to claim 26, wherein the radio connection unit is a user equipment.

31. Radio connection unit module comprising means for realizing the method according to claim 1 in a radio connection unit for a wireless communications system to be used as first radio connection unit.

32. Radio connection unit module comprising means for realizing the method according to claim 1 in a radio connection unit for a wireless communications system to be used as second radio connection unit.

33. Radio connection unit module comprising means for realizing the method according to claim 1 in a radio connection unit for a wireless communications system to be used as first or second radio connection unit.

34. Radio connection unit module according to claim 31, wherein the radio connection unit module is a base station module or a user equipment module.

35. Radio communications system, comprising at least one radio connection unit with means for realizing as first radio connection unit and one for a second radio connection unit the method according to claim 1.

36. Radio communications system according to claim 35, wherein the radio connection units used as first radio connection unit are base stations and/or user equipments.

37. Radio communications system according to claim 35, wherein the radio connection units used as second radio connection unit are base stations and/or user equipments.

38. Radio communications system according to claim 35, wherein at least one of the radio connection units comprises means for realizing a method for controlling the weighting of a data signal in the at least two antenna elements of a first radio connection unit of a radio communications system, which data signal is to be distributed to at least two beams for parallel transmission of the data signal in at least two at least partly different streams to a second radio connection unit with at least one antenna element, the beams being formed by weighting the data signal in the antenna elements with a set of weights for each beam, the method comprising:
determining in the second radio connection unit a weight information enabling the first radio connection unit to determine the sets of weights for at least two suitable beams for transmission of a data signal from the first radio connection unit to the second radio connection unit;
evaluating in the second radio connection unit the stationary structure of received channels for determining data rates to be used for each of the at least two suitable beams;
transmitting the determined weight information and the determined data rates to the first radio connection unit; and
distributing the data signal in the first radio connection unit to at least two sets of weights determined from the received weight information and transmitting the data signals simultaneously via the at least two formed beams with the determined data rates.

39. Radio connection unit for a wireless communications system comprising at least two antenna elements and means for realizing as first radio connection unit the method according to claim 18.

40. Radio connection unit for a wireless communications system comprising at least one antenna element and means for realizing as second radio connection unit the method according to claim 18.

41. Radio connection unit for a wireless communications system comprising at least two antenna elements, and means for realizing as first radio connection unit and as second radio connection unit the method according to claim 18.

42. Method according to claim 3, wherein the second radio connection unit determines the data rates to be used for the at least two determined beams in a way that a total data is fixed.

43. A device, comprising:
determining unit configured to determine a weight information enabling a radio connection unit to determine sets of weights for at least two suitable beams for transmission of a data signal from the first radio connection unit to the second radio connection unit;
evaluation unit configured to evaluate a stationary structure of received channels to determine data rates to be used for each of the at least two suitable beams;
a first transmitter unit configured to transmit the determined weight information and the determined data rates to the radio connection unit;
distributing unit configured to distribute the data signal in the radio connection unit to at least two sets of weights determined from the received weight information; and
wherein the transmitter unit is further configured to transmit the data signals simultaneously via the at least two formed beams with the determined data rates.

44. The device according to claim 43, further comprising at least two transceiver elements configured to send or receive signals

45. The device according to claim 43, wherein the device is a base station.

46. The device according to claim 43, wherein the device is a user equipment.

47. A system, comprising:
a first radio connection unit wherein the first radio connection unit includes at least two transceiver elements; and
a second radio connection unit, wherein the second radio connection unit includes at least two transceiver elements,
wherein the first radio connection unit is configured to control the weighting of a data signal in the at least two transceiver elements and the data signal is to be distributed to at least two beams for parallel transmission of the data signal in at least two at least partly different streams to the second radio connection unit the beams being formed by weighting the data signal in the antenna elements with a set of weights for each beam,
wherein the second radio connection unit is configured to,
determine a weight information enabling the first radio connection unit to determine the sets of weights for at least two suitable beams for transmission of a data signal from the first radio connection unit to the second radio connection unit;
evaluate the stationary structure of received channels for determining data rates to be used for each of the at least two suitable beams;
transmit the determined weight information and the determined data rates to the first radio connection unit,
wherein the first radio connection unit is configured to distribute the data signal to at least two sets of weights determined from the received weight information, and transmit the data signals simultaneously via the at least two formed beams with the determined data rates.

48. The system according to claim 47, wherein the first radio connection unit is one of a base station or a user equipment.

49. The system according to claim 47, wherein the second radio connection unit is one of a base station or a user equipment.

50. The system according to claim 47, wherein each of the first radio connection unit and the second radio connection unit is at least one of a base station or a user equipment.
